(19) United States
(12) Patent Application Publication
(10) Pub. No.: US 2007/0025695 A1
(43) Pub. Date: Feb. 1, 2007

(54) Method and apparatus for making a recording space for video signals on a recording medium

(75) Inventors: Dae Kyu Kim, Incheon-si (KR); Byeong Cheol Kim, Seongnam-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/492,851

(22) Filed: Jul. 26, 2006

(30) Foreign Application Priority Data
Jul. 26, 2005 (KR) 10-2005-0067920
Jul. 26, 2005 (KR) 10-2005-0067930
Jul. 26, 2005 (KR) 10-2005-0067909

(51) Int. Cl. G11B 15/04; H04N 7/00

(52) U.S. Cl. 386/95

(57) ABSTRACT

The present invention relates to a method and apparatus for securing a space for recording video, e.g., a broadcast program on a recording medium. When distribution of empty spaces scattered in a recording medium satisfies a particular condition, e.g., whether the size of a deleted program or the size of the entire empty space can accommodate video signals of a prescribed recording hours or whether the size of the empty space located at the last position is smaller than the size of all of the remaining empty spaces, the present invention moves and records recorded programs scattered in a recording medium to be continuous with one another, thereby making empty spaces scattered in the recording medium a single continuous empty space.

### BACKGROUND OF THE INVENTION

1. Field of the Invention

The present invention relates to a method and apparatus for making a space for recording video, e.g., a broadcast program on a recording medium.

2. Background of the Related Art

As broadcast channels including terrestrial, cable, satellite TV, etc. are diversified, it is frequent that a user records a program to watch into a disc medium which is digital recording medium by reserved recording and watches the program at his/her convenience. Therefore, many programs are reproduced after recording and deleted from the disc after playback.

Meanwhile, it is a common observation that a user selects and reproduces a recorded program according to his/her preference irrespective of the recording order of programs, after which the reproduced program is eventually deleted. Therefore, unless all of the recorded programs are reproduced sequentially at a time, recorded programs remaining in a disc are laid scattered as shown in FIG. 1; accordingly, available recording spaces (101_{N}) also become scattered.

Typical disc media widely used for recording digital videos are DVD+R and DVD-R. DVD-R is of a format that data is recorded randomly on a disc medium and a set of the randomly recorded data blocks is managed as a single recorded program, whereas DVD+R is of a format that a program unit generated by an one-time recording must form a data section recorded continuously.

Therefore, when a recording medium with a recording space as shown in FIG. 1 is DVD+R, the entire available recording space is about two hours in the case of EP mode where data bit rate is 2.45 Mbps; however, if the size of an empty space at the last position (101₃) is about 30 minutes in EP mode, a broadcast program which exceeds the corresponding time cannot be recorded. It is because a typical recording apparatus starts recording from the last empty space for continuous recording when a recording medium is of the type where a continuous recording section can be managed as a single recorded program, even though empty spaces may exist inside the recording medium (101₁, 101₂ in the example of FIG. 1). Subsequently, in the example of FIG. 1, if recording is preceded, recording is carried out only for 30 minutes or so and stopped thereafter even though an available recording space exists inside the recording medium.

### SUMMARY OF THE INVENTION

The present invention is directed to provide a method and apparatus for gathering scattered available recording spaces into a continuous available recording space in order for a user to fully utilize available recording spaces of a recording medium requiring a continuous space for recording such as DVD+R.

To achieve the objective above, the present invention, when distribution of empty spaces scattered in a recording medium satisfies a particular condition, moves and records one or more programs recorded in a recording medium to be continuous with one another, thereby making empty spaces scattered in the recording medium a single continuous empty space.

In one embodiment in accordance with the present invention, empty spaces scattered in a recording medium are gathered in order for a continuous empty space to be formed in outer periphery.

In one embodiment in accordance with the present invention, at the time of deleting a recorded program, if an empty space exists adjacent to the recorded program and the sum of sizes of the recorded program and the empty space is larger than the size of an empty space in outermost periphery, empty spaces are gathered.

In another embodiment in accordance with the present invention, if the size of a first empty space in outermost periphery of the recording medium is smaller than the sum of sizes of empty spaces except for the first empty space existing in the recording medium, empty spaces are gathered.

In a yet another embodiment in accordance with the present invention, if all of empty spaces scattered in a recording medium can accommodate recording of video signals lasting prescribed hours, empty spaces are gathered.

In a further embodiment in accordance with the present invention, at the time of deleting a recorded program, if the size of the recorded program can accommodate recording of video signals longer than a prescribed time, empty spaces are gathered.

In a yet further embodiment in accordance with the present invention, at the time of deleting a recorded program, if the sum of sizes of an empty space created by the recorded program and one or more existing empty spaces can accommodate recording of video signals longer than a prescribed time, empty spaces are gathered.

In one embodiment in accordance with the present invention, after deleting a program not in the last position among programs recorded in a recording medium, operations of checking conformance to the particular condition and gathering empty spaces according thereto are carried out.

In another embodiment in accordance with the present invention, operations of checking conformance to the particular condition and gathering empty spaces according thereto are carried out after execution of initial operations on a recording medium.

In a yet another embodiment in accordance with the present invention, operations of checking conformance to the particular condition and gathering empty spaces according thereto are carried out before start of recording a broadcast program reserved for timer recording.

In a further embodiment in accordance with the present invention, when a user sets reserved recording of a broadcast program and turns off operation power, operations of checking conformance to the particular condition and gathering empty spaces according thereto are carried out.

In one embodiment in accordance with the present invention, a user is inquired of whether to carry out an operation of gathering scattered empty spaces and the operation is carried out upon acceptance by the user.

### BRIEF DESCRIPTION OF THE DRAWINGS

The invention will be described in detail with reference to the following drawings in which like reference numerals refer to like elements wherein:

FIG. 1 illustrates an example where empty spaces are scattered as recorded programs recorded in a disc medium go through a selective deletion operation;

FIG. 2 illustrates a structure of one embodiment of a recording/playback apparatus of an optical recording medium, where a method for securing a program recording space in accordance with the present invention is carried out;

FIG. 3 illustrates an exemplary menu screen registering reserved recording of a broadcast program;

FIGS. 4 to 7 illustrate respective cases where an operation of gathering empty spaces in accordance with an embodiment of the present invention is carried out; and

FIG. 8 illustrates an exemplary guidance screen inquiring a user about whether to carry out an operation of gathering empty spaces in accordance with one embodiment of the present invention.

### DETAILED DESCRIPTION OF PREFERRED EMBODIMENTS

Hereinafter, according to the present invention, preferred embodiments of a method and apparatus for securing a video signal recording space will be described in detail with reference to appended drawings.

FIG. 2 illustrates a structure of one embodiment of a recording/playback apparatus of an optical recording medium, where a method for securing a program recording space in accordance with the present invention is carried out

A recording/playback apparatus of an optical recording medium shown in FIG. 2 comprises a tuner 10 resonating at television broadcast signals, an encoder 12 converting the resonated video signals into digital signals and encoding the digital signals, e.g., in MPEG format and decomposing and muxing the encoded data into audio and video PES (Packetized Elementary Stream) packets, a recording DSP unit 13 configuring the PES packet sequence by ECC (Error Correction Code) block format and demodulating the configured PES packet sequence to signals for recording, an optical drive 14 feeding recording beam drive currents to an optical pickup 2 according to input signals, the optical pickup 2 reading out signals of an optical recording medium 1 such as DVD+R/-R or applying beams according to signals from the optical drive 14 to the optical recording medium 1, an RF unit 20 extracting electrical signals for binarized playback signals, focusing error (FE) signals, and tracking error (TE) signals from the read out signals, a playback DSP unit 21 reconstructing digital data from binarized playback signals and separating management data and navigation data from the reconstructed data, a decoder 22 separating audio and video PES packets from muxed PES packet sequence which is output data of the playback DSP unit 21 and decoding the separate audio and video PES packets into respective A/V signals, an OSD unit 33 generating character and graphic signals, a synthesizer 24 synthesizing the video signals and the character and graphic signals, a servo control unit 31 controlling the optical pickup 2 and the incident beams (which are used for recording and reproducing) according to the focusing error signals and tracking error signals and controlling a spindle motor M rotating the optical recording medium 1, memory 32 where data such as a list of reserved recording items and navigation information are stored, a clock unit 34 tracking current date and time, and a microcomputer 30 processing user inputs and controlling operations of recording/playback as a whole.

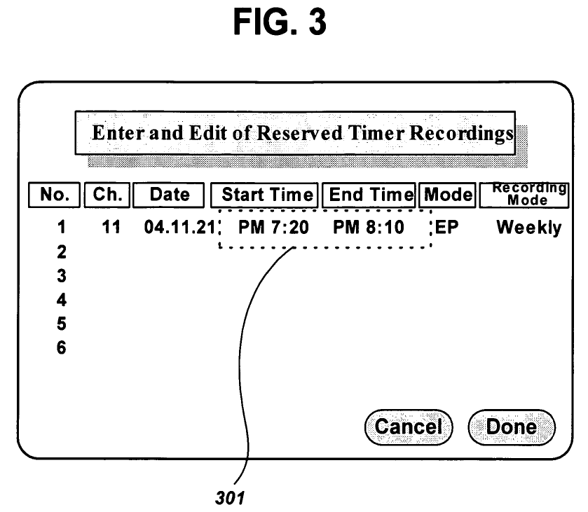

When a user selects a reserved recording menu by using a user input means (not shown) installed to the recording/playback apparatus of FIG. 2, e.g., an input apparatus such as a remote controller, the microcomputer 30 controls the OSD unit 33, thereby configuring and displaying a reserved recording menu as shown in FIG. 3. Reception of a remote controller's signals is accomplished through a well-known infrared receiving means (not shown), which is interpreted by the microcomputer 30. While a menu being displayed, the user sets a desired channel for reserved recording, recording time (start and end time including date), recording mode (e.g., one from among HQ, SP, LP, EP, and SLP), and recording pattern by using key inputs on a remote controller. At this point, recording pattern can be one-time, daily, or weekly.

When the user sets reservation items as above and selects ‘complete’, the microcomputer 30 registers the reserved items on a list of reserved recording in the memory 32. By the procedure above, programs desired by the user are all registered on a list of reserved recording in the memory 32. After the setting of reserved recording as above, the user usually let the operation power of the recording/playback apparatus turned off, thereby making the apparatus in waiting state. In waiting state, except for constituting elements needed for operations of checking time and user request for power ON/OFF, operational power is not provided.

The microcomputer 30 monitors whether current date/time tracked by the clock unit 34 in waiting state is sufficiently advanced than recording start time of any one of the designated reserved recording items (e.g., the microcomputer 30 checks whether it is 30 minutes of advance). When it becomes 30 minutes before the start time, operational power is applied to all of the constituting elements, thereby making the elements in running state; the microcomputer 30 then controls the servo control unit 31 so that the installed disc 1 is rotated to reach a proper playback speed. For description of the present invention, the installed disc 1 is assumed to be a disc medium of a format managing a continuously recorded data section as a single recorded program, e.g., DVD+R disc. Decision on a disc type of an installed disc medium is made by a well-known technology.

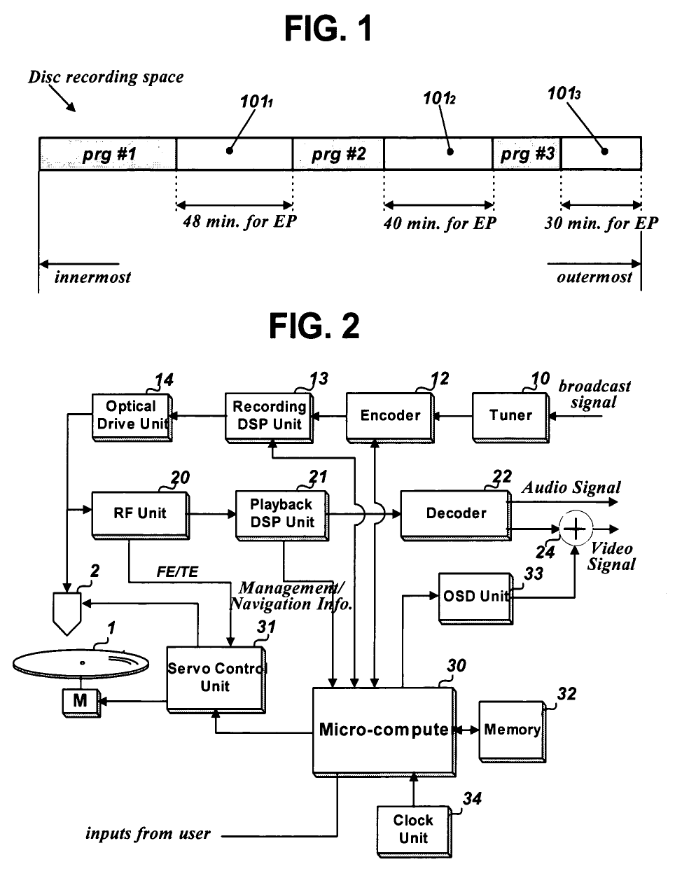

The microcomputer 30, by controlling the servo control unit 31, moves the optical pickup 2 to a navigation area of a disc 1 and reads out a navigation file recorded in the area. Signals read by the optical pickup 2 are transformed into binary signals by the RF unit 20 and reconstructed to navigation information by the playback DSP unit 21, thereby being provided to the microcomputer 30. The navigation information is stored in the memory 32 and referred to by the microcomputer 30 in case of need; the microcomputer 30 can calculate recording areas of respective programs recorded in a currently installed disc and associated empty spaces by utilizing the navigation information. Hereinafter, for the purpose of understanding of the present invention, an installed disc medium 1 is assumed to have recorded data distributed as shown in FIG. 1. Therefore, the microcomputer 30 roughly estimates the sizes of empty spaces 101₁,101₂,101₃ scattered in the installed disc medium 1 to be 882 Mbytes, 772 Mbytes, and 551 Mbytes.

The microcomputer 30 identifies recording mode for an item designated as reserved recording of the earliest order and calculates available recording time of an individual empty space associated therewith. If the designated recording mode is, e.g., EP (data bit rate is 2.45 Mbps), as shown in FIG. 1, available recording time of an individual empty space becomes 48, 42, and 30 minutes or so.

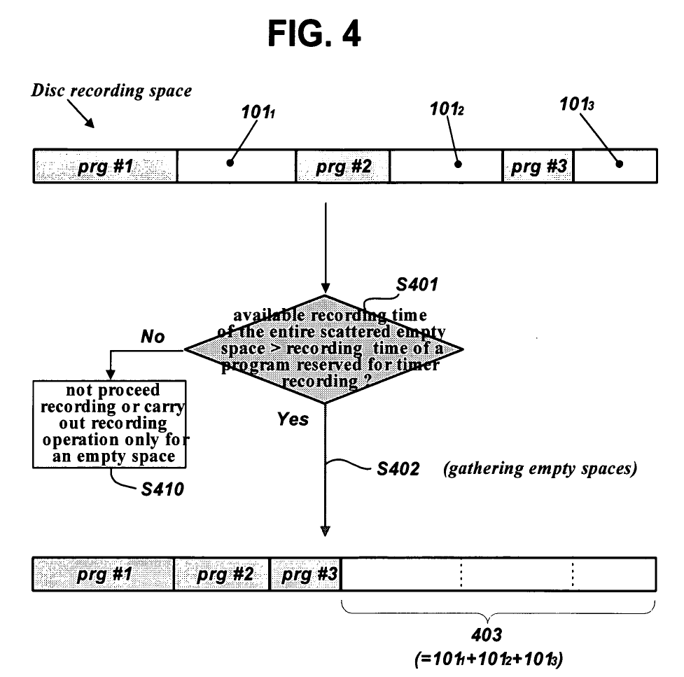

The microcomputer 30 compares recording time of a program to be recorded (which is 50 minutes 301 in the example of FIG. 3) in accordance with reserved recording items with available recording time in accordance with recording mode of an empty space 1013 located at the last position. If the empty space cannot accommodate a program reserved for timer recording, as shown in FIG. 4, available recording time (120 minutes or so) in accordance with recording mode of the entire empty space (sum of scattered empty spaces) is compared with recording time of a program reserved for timer recording S401. If available recording time of the entire empty space is larger than recording time of a program reserved for timer recording, operations of creating continuous empty spaces at outermost periphery are carried out S402.

In order to make continuous empty spaces, the microcomputer 30 reads data of a second program prg #2 recorded next to a first empty space 101₁ and stores the data in the memory 32. The microcomputer 30 then records the data from the head of the first empty space 101₁ through the recording DSP unit 13 and the optical drive unit 14. Since the temporary storage space of the memory 32 has a limited capacity, program data are read as much as the memory 32 accommodates and the last reading position is recorded; the position of recording beam of the optical pickup 2 is moved to the first empty space 101₁ by the servo control unit 31 and temporarily stored data are recorded in the memory 32 starting from the position. After all of temporarily stored data have been recorded, the last recording position is recorded, after which playback beam of the optical pickup 2 is moved to the previously recorded last playback position and data of a recorded program are read out subsequently and the data are recorded subsequent to the previously recorded recording position. If the procedure above is carried out on the second recorded program prg #2, the first program prg #1 and the second program prg #2 become jointly recorded one after the other. Then, from navigation information stored in the memory 32, the microcomputer 30 updates recording position information about the second program prg #2 to accommodate the moved position, thereby completing a first movement of a recorded program.

Next, data of a third recorded program prg #3 are read and recorded subsequent to the tail of the previously moved second program prg #2 and in the same way, from navigation information of the memory 32, information about recording position of the third program prg #3 is updated according to a moved position. Thus, all of scattered empty spaces become aggregated to form a single continuous empty space (403 area of FIG. 4) subsequent to a program recording area. After the process of gathering empty spaces is completed as above, the microcomputer 30 immediately records the updated navigation information in the memory 32 into a navigation file of the disc 1; it is intended to prevent a case where disc withdrawal occurs before update of a navigation file on a disc medium subsequent to movement recording of a program, thereby bringing about playback failure of a program recorded by movement due to inconsistency between actual position of recorded data and navigation information.

If, during the previous comparison stage S401, the entire available recording time according to recording mode of scattered recording areas is shorter than the recording time of a program reserved for timer recording, recording may not be carried out at reserved time or an ordinary recording operation, where recording is carried out only for the empty space 101₃ at the last position, is carried out S410. In another embodiment of the present invention, even when the entire available recording time according to recording mode of scattered recording areas is shorter than the recording time of a program reserved for timer recording, scattered empty spaces are gathered as described above and a part of a broadcast program, which the gathered empty space can accommodate, can be recorded at a designated recording time.

When the operation of gathering empty spaces as described above is finished, the microcomputer 30 checks whether the current tracking time of the clock unit 34 corresponds to recording start time of a program reserved for timer recording and if it becomes the start time, the microcomputer 30 controls the tuner 10 to resonate to a channel reserved for timer recording.

Accordingly, video signals received from a resonated channel are encoded in MPEG format by the encoder 12 and configured into PES packets. The packet sequence is then configured into ECC block format for error correction by the recording DSP unit 13 and demodulated into recording signals, thereby being recorded along physical tracks starting from the head of a single empty space 403 at outermost periphery secured by the disc 1. In other words, recording of a broadcast program belonging to reserved recording items is started. During recording, the microcomputer 30 configures recorded data in units of navigation (it is referred to as VOBU) and generates time entries, each of which records the size of an individual navigation unit and time length of a presentation. Configuration in terms of navigation units is carried out by one or more than one GOP (Group of Pictures) unit ranging from 0.4 to 1 second and being encoded by the encoder 12. Since the aforementioned procedure does not have direct relevance to the present invention, more detailed description thereupon is omitted.

During recording as above, when current time of the dock unit 34 reaches recording end time, recording as well as generation of an individual time entry is terminated and navigation information about a recorded program is created. Navigation information created at this stage includes cell information about video recording section, program information (PGI) making a reference to the cell information, and program chain information (PGC) enabling management of recorded section as a single title. When information as described above is created, the entire information is recorded in a navigation file belonging to a navigation recording area of the disc medium 1 along with time entry information created during recording. Since existing navigation information is already loaded in the memory 32 at the time of initial loading of the disc medium 1, the loaded navigation information is updated by adding navigation information created according to the above recording thereto and the updated entire navigation information is recorded in a navigation file of the disc 1 through the recording DSP unit 13 and recording operation is terminated by entering into a waiting mode checking a user input.

Through the procedure as above, even when a scattered empty space cannot accommodate recording of a single broadcast program, if the total sum of empty spaces can accommodate recording time of the broadcast program, the broadcast program can be recorded as a whole.

The procedure of gathering empty spaces, when a user requests power-off at different time from the recording time of a reserved recording item, e.g., after setting reserved recording, compares available recording time according to recording mode of scattered empty spaces with recording time of a program reserved for timer recording and carries out the operation of gathering empty spaces according thereto, thus entering into a waiting mode.

In the embodiment described above, available recording time according to recording mode of empty spaces were compared with recording time of a program reserved for timer recording, on the other hand, in another embodiment of the present invention, estimated recording data size according to recording mode of recording time of a program reserved for timer recording is compared with the size of empty spaces and then whether operation of gathering empty spaces is carried out can be determined.

In the following, a yet another embodiment in accordance with the present invention for securing a continuous recording space is described.

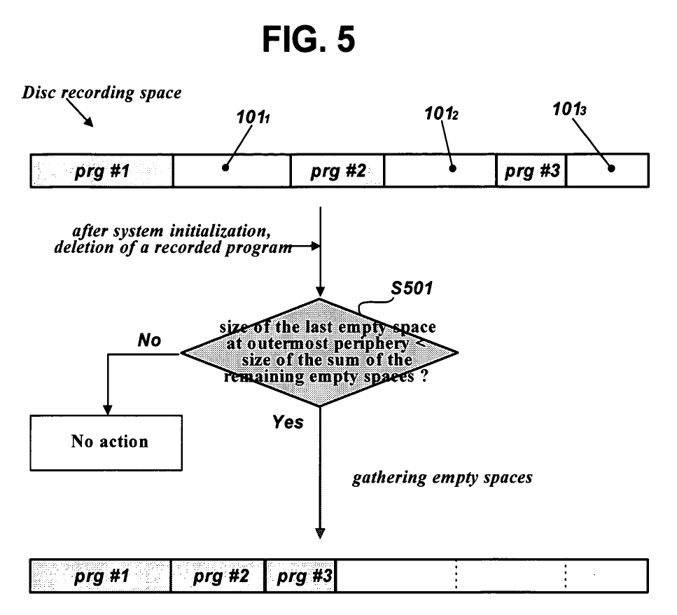

As shown in FIG. 5, the present embodiment is carried out when the size of the last empty space 101₃ of the disc medium 1 is smaller that the sum of sizes of scattered empty spaces except for the last empty space S501, which, in the example of FIG. 1, is the sum of sizes of two empty spaces 101₁, 101₂ preceding the last empty space. A recording apparatus which records in a disc of a format managing continuously recorded sections as a single recorded program, e.g., DVD+R, as mentioned previously, in order to prevent suspension of recording due to absence of continuous empty spaces during recording, usually starts recording in the last empty space 101₃ rather than start video recording in one of interior empty spaces (101₁ or 101₂). Therefore, when the size of the last empty space is small, it is advantageous to put interior empty spaces in the last empty space to accommodate recording of as much time as possible upon a user's request for recording. However, in order to prevent the operation of gathering empty spaces from being carried out even when the size of an interior empty space is small, the present embodiment is carried out when the sum of sizes of interior empty spaces (except for the last empty space among the scattered empty spaces) is larger than the size of the last empty space.

Operation of gathering empty spaces is carried out when distribution of empty spaces is checked and the condition S501 is satisfied after an initial operation, e.g., an operation such as adjustment of servo characteristics for recording on a disc medium or reproducing thereof, is carried out with the application of operational power to an apparatus.

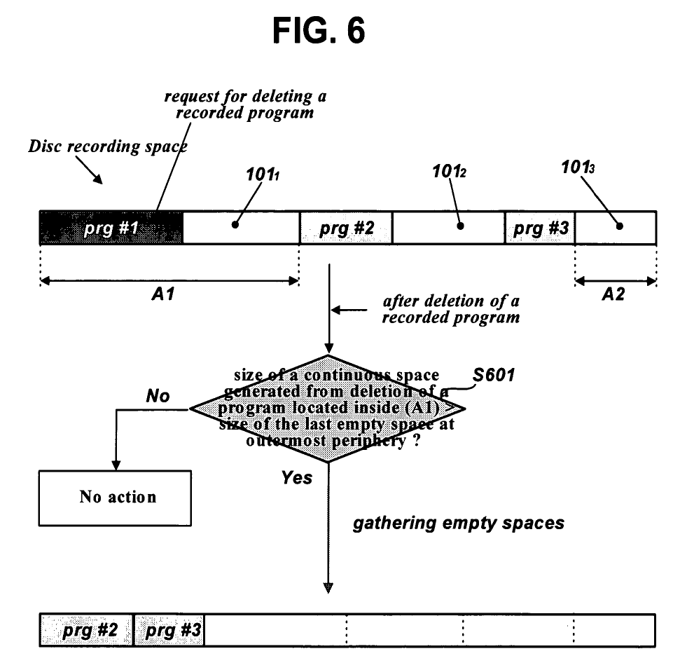

When a user selects a particular recorded program and requests deletion of the program, checking the condition described above S501 and an operation of gathering empty spaces according thereto can be carried out after the corresponding area of the recorded program is rendered into an empty space by modifying navigation information. In another embodiment in accordance with the present invention, as shown in FIG. 6, instead of the condition S501, at the time of deleting a recorded program, when the deleted program is located inside (in other words, for the case of a recorded program located away from the last empty space) and the size of a continuous space generated from the deletion (the size of a recorded program or size of a continuous space including a recorded program and empty spaces adjacent thereto) is larger than the size of the last empty space 101₃, S601, the operation of gathering empty spaces described above can be carried out.

In a further embodiment of the present invention, instead of the condition S501 for carrying out the operation of gathering empty spaces, the operation of gathering empty spaces described above can be carried out when a ratio (SS Last/SS Others) of the size of the last empty space (SS Last) to the size of sum of scattered empty spaces except for the last empty space (SS_Others) is less than a prescribed ratio (ct). For example, if the prescribed ratio ct is set to 2, gathering empty spaces is carried out when the size of a continuous empty space generated by combining all of scattered empty spaces becomes larger than the size of the last empty space by more than 50%. The prescription of a ratio as above can be set by a user through environment setting of the recording/playback apparatus.

Hereinafter, a yet further embodiment for securing a continuous recording space in accordance with the present invention is described.

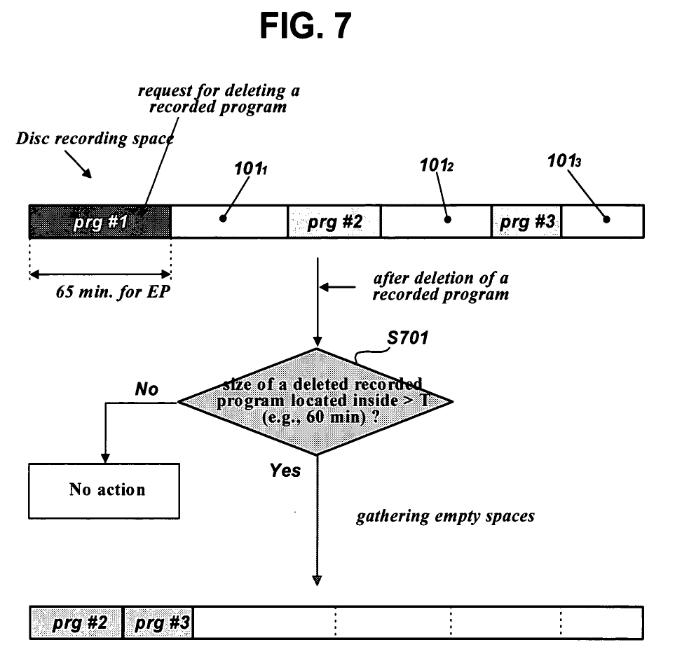

As shown in FIG. 7, in the present embodiment, gathering empty spaces is carried out when, at the time of deleting a particular program, the particular program is not a program recorded at the last position and the space of the deleted program is larger than that of a prescribed reference time (a value corresponding to a typical broadcast time of an ordinary program, e.g., 60 minutes) S701. If the recording/playback apparatus does not get a particular setting for recording mode from a user, calculation of recording time for a deleted space is carried out by employing a recording mode which is automatically set. For examples, when a particular setting for recording mode is not given from the user, the size of the space of a deleted program is calculated based on the assumption of EP mode and available recording time is estimated accordingly.

Therefore, if a deleted space can accommodate one of typical broadcast programs, by combining the broadcast program into a continuous empty space, as described above, a situation can be avoided, where a recording apparatus recording on a disc of a format managing a continuously recorded block as a single recorded program, e.g., DVD+R, in spite of having secured a considerable space for accommodating a program, confronts suspension or incapability of recording due to insufficiency of the last empty space by starting recording in the last empty space instead of starting recording of video data from an interior empty space.

In an embodiment of FIG. 7, gathering of empty spaces is carried out when the space size of a deleted interior program is larger than that of a prescribed time; in another embodiment of the present invention, gathering of empty spaces is carried out when an empty space is located adjacent to the deleted program and the sum of sizes of the empty space and the deleted program is larger than that of a prescribed time. In a yet another embodiment of the present invention, gathering of empty spaces can be carried out when the sum of the space size generated from the deleted program and the total size of existing empty spaces rather than the size of a single deleted program is larger than that of a prescribed time.

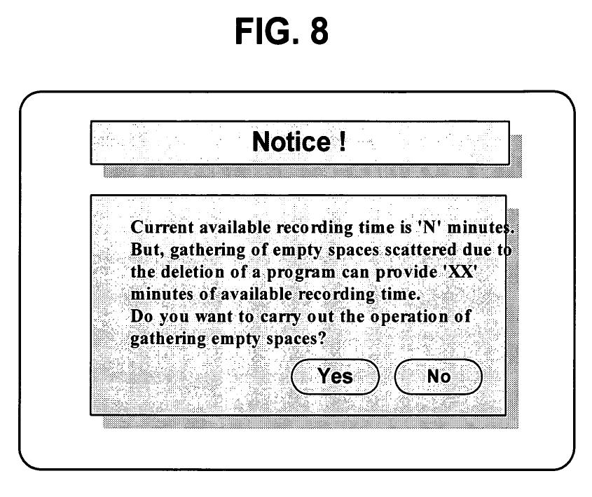

In another embodiment of the present invention, the microcomputer 30, instead of automatically carrying out an operation of gathering empty spaces with a condition met at the time of deleting a particular program by a user, as shown in FIG. 8, through the OSD unit 33, can display current available time for continuous recording (available recording time for the last empty space) and the entire available recording time obtained by gathering empty spaces including an empty space generated by deleting a recorded program and an inquiry of whether to carry out an operation of gathering empty spaces and carry out the operation of gathering empty spaces when the user accepts as a response to the inquiry. Therefore, by incorporating checking a user's request on the operation of gathering empty spaces, when the user wants to request a recording apparatus to carry out another operation immediately after deletion of a particular program, the apparatus can avoid unnecessary waiting due to the operation of gathering empty spaces that is carried out automatically.

In a yet another embodiment of the present invention, the microcomputer 30, automatically carrying out an operation of gathering empty spaces with a condition met at the time of deleting a particular program by a user and receiving a request to stop the operation during the operation of gathering empty spaces, e.g., a request to reproduce a recorded program, can display guide information indicating that an operation of gathering empty spaces is being carried out and the requested operation can be carried out after when the operation of gathering empty spaces is completed. The requested operation is carried out automatically after gathering empty spaces and associated update of a navigation information file.

According to the present invention described above in detail, in the case of a disc medium where a recorded program requires a continuous space, empty spaces of the recording medium are fully utilized so that video contents, e.g., a broadcast program can be recorded as many hours as possible, thereby enhancing utilization of a recording medium.

The present invention is not limited to the foregoing description of preferred embodiments and those skilled in the art may easily understand that the invention and various embodiments can be utilized with improvements, modifications, substitutions, or additions within the scope of the invention. If the improvements, modifications, substitutions, or additions belong to the scope of the invention as defined by the following appended claims, the spirit should also be regarded to belong to the present invention.

What is claimed is:

1. A method for managing programs recorded on a recording medium, comprising:
checking whether distribution of empty spaces on the recording medium satisfies a predetermined condition; and
when satisfied, gathering empty spaces scattered on the recording medium by moving and recording one or more programs recorded on the recording medium.

2. The method of claim 1, wherein the checking step, if, at time of deleting a recorded program, an empty space exists adjacent to the deleted recorded program, checks whether sum of sizes of the deleted recorded program and the empty space is larger than size of an empty space at an outermost periphery.

3. The method of claim 1, further comprising the step of
updating navigation information about the moved program according to a moved position, and recording the updated navigation information on the recording medium.

4. The method of claim 1, wherein the gathering step inquires a user of whether to execute operation of gathering empty spaces and carries out operation of the empty space gathering upon the user's instruction of execution.

5. The method of claim 1, wherein the checking step checks whether size of a first empty space at an outermost periphery of the recording medium is smaller than sum of empty spaces existing on the recording medium excluding the first empty space.

6. The method of claim 1, wherein the checking and the gathering steps are carried out after deleting a program not at an end position among programs recorded on the recording medium.

7. The method of claim 1, wherein the checking and the gathering steps are carried out after execution of initial operations for the recording medium.

8. The method of claim 1, wherein the checking and the gathering steps are carried out before start of recording a broadcast program reserved for timer recording.

9. The method of claim 1, wherein the checking and the gathering steps are carried out when a user sets timer recording of a broadcast program on a recording apparatus and turns off the recording apparatus.

10. The method of claim 1, wherein the checking step checks whether an entire empty space scattered on the recording medium can accommodate recording of video signals lasting for a set time.

11. The method of claim 10, wherein the video signals are given from a broadcast program designated as a time recording entry by a user.

12. The method of claim 10, wherein the checking and the gathering steps are carried out when an empty space at outermost periphery of the recording medium cannot accommodate recording of video signals for a prescribed time duration.

13. The method of claim 10, wherein the checking step calculates available recording time for the entire empty space in accordance with data bit rate determined by recording mode of the video signals and checks whether to allow recording by comparing the calculated time with the prescribed time duration.

14. The method of claim 10, wherein the checking step checks whether to allow recording by comparing size of the entire empty space with size of data to be created during the prescribed time duration in accordance with data bit rate determined by recording mode of the video signals.

15. The method of claim 1, wherein the checking step, at time of deleting a recorded program, checks whether size of the deleted recorded program can accommodate recording of video signals longer than a prescribed time.

16. The method of claim 1, wherein the checking step, at time of deleting a recorded program, checks whether sum of sizes of an empty space created by the deleted recorded program and one or more already-existing empty spaces can accommodate recording of video signals longer than a prescribed time.

17. The method of claim 1, wherein the gathering step gathers the scattered empty spaces into a single contiguous empty space at outermost periphery of the recording medium.

18. The method of claim 1, wherein the recording medium is of a format that manages a contiguously-recorded data recording block as a single recorded program.

19. The method of claim 18, wherein the recording medium is DVD+R.

20. An apparatus for recording video signals on a recording medium, comprising:
a recording unit recording input video signals onto a continuous empty space of the recording medium;
a reproducing unit reading out recorded signals from the recording medium; and
a control unit checking whether distribution of empty spaces on the recording medium satisfies a prescribed condition and if satisfied, moving and recording one or more programs recorded on the recording medium by controlling the reproducing unit and the recording unit to gather empty spaces scattered on the recording medium.

21. The apparatus of claim 20, wherein if, at time of deleting a recorded program, an empty space exists adjacent to the deleted recorded program, the control unit checks a condition that sum of sizes of the deleted recorded program and the empty space is to be larger than size of an empty space at an outermost periphery.

22. The apparatus of claim 20, wherein the control unit checks a condition that size of a first empty space at an outermost periphery of the recording medium is to be smaller than sum of empty spaces existing on the recording medium excluding the first empty space.

23. The apparatus of claim 20, wherein the control unit checks a condition that an entire empty space scattered on the recording medium can accommodate recording of video signals lasting for a set time.

24. The apparatus of claim 20, wherein the control unit, at time of deleting a recorded program, checks a condition that size of the deleted recorded program can accommodate recording of video signals longer than a prescribed time.

25. The apparatus of claim 20, wherein the control unit, at time of deleting a recorded program, checks a condition that sum of sizes of an empty space created by the deleted recorded program and one or more already-existing empty spaces can accommodate recording of video signals longer than a prescribed time.

26. The apparatus of claim 20, wherein the control unit carries out operations of the checking and the empty space gathering after deleting a program not at a last position among programs recorded on the recording medium.

27. The apparatus of claim 20, wherein the control unit carries out operations of the checking and the empty space gathering after execution of initial operations for the recording medium.

28. The apparatus of claim 20, wherein the control unit carries out operations of the checking and the empty space gathering before start of recording a broadcast program reserved for timer recording.

29. The apparatus of claim 20, wherein the control unit carries out operations of the checking and the empty space gathering when a user sets a timer recording of a broadcast program and turns off operation power.

30. The apparatus of claim 20, wherein the recording medium is of a format that manages a contiguously-recorded data recording block as a single recorded program.
